(19) United States
(12) Patent Application Publication
(10) Pub. No.: US 2023/0358288 A1
(43) Pub. Date: Nov. 9, 2023

(54) TOOL AND METHOD FOR MEASURING BRAKE FRICTION MATERIAL

(71) Applicant: ArvinMeritor Technology, LLC, Troy, MI (US)

(72) Inventors: Vishwanath Ramachandra, Bangalore (IN); Sanjeev Kulkarni, Bangalore (IN); Sathyanarayanaraju Nagaraju, Bangalore (IN)

(73) Assignee: ArvinMeritor Technology, LLC, Troy, MI (US)

(21) Appl. No.: 18/306,444

(22) Filed: Apr. 25, 2023

(30) Foreign Application Priority Data
May 6, 2022 (IN) 202211026393

(51) Int. Cl. F16D 66/02

(52) U.S. Cl. CPC F16D 66/023

(57) ABSTRACT

A tool and method of measuring friction material of a brake pad assembly. The tool includes a sleeve and a plunger that is received in the sleeve. The plunger may have a probe that extends through a sleeve slot and a ground plate that is moveably disposed on the sleeve.

### TECHNICAL FIELD

This disclosure relates to a tool for measuring friction material of a brake pad assembly and at least one method of measuring the friction material of the brake pad assembly.

### BACKGROUND

A brake pad wear monitoring system is disclosed in U.S. Patent Publication No. 2016/0146279.

### SUMMARY

In at least one embodiment a tool for measuring friction material of a brake pad assembly is provided. The tool includes a sleeve and a plunger. The sleeve includes a sleeve hole and a sleeve slot. The sleeve hole extends along an axis. The sleeve slot extends through the sleeve from the sleeve hole to an outer side of the sleeve that faces away from the axis. The plunger is received in the sleeve hole and is moveable along the axis with respect to the sleeve. The plunger includes a plunger body and a probe. The plunger body is received in the sleeve hole and has a plunger indicator region that provides visual information indicative of a state of wear of friction material of a brake pad assembly. The probe extends from the plunger body through the sleeve slot and past the outer side of the sleeve.

The sleeve may have a first end and a second end. The first end may face toward the brake rotor. The second end may be disposed opposite the first end. The sleeve hole may extend between the first end and the second end of the sleeve. For instance, the sleeve hole may extend from the first end to the second end. The sleeve slot may extend from the first end toward the second end.

The tool may include an end cap. The end cap may be disposed at the first end of the sleeve. The end cap may inhibit removal of the plunger from the sleeve hole. The end cap may define an end of the tool.

The tool may include a ground plate. The ground plate may be moveably disposed on the sleeve. The ground plate may have a ground plate hole through which the sleeve may extend. The ground plate may be positioned along the axis between the probe and the second end of the sleeve.

The sleeve may have a protrusion. The protrusion may be disposed proximate the second end of the sleeve. The protrusion and the probe may inhibit removal of the ground plate from the sleeve.

The sleeve may have a sleeve indicator region. The sleeve indicator region may provide visual information indicative of the state of wear of friction material of an outboard brake pad assembly. The sleeve indicator region may be provided on the outer side of the sleeve.

In at least one embodiment a method of measuring friction material of a brake pad assembly is provided. The method includes providing a tool that has a sleeve that defines a sleeve hole and a sleeve slot, a plunger that has a plunger body that is received in the sleeve hole and that has a plunger indicator region, and a probe that extends from the plunger body through the sleeve slot. The tool engages with a friction surface of a brake rotor that is configured to be engaged by the friction material. The probe engages with a backplate of the brake pad assembly upon which the friction material is disposed. The friction material is measured with the plunger indicator region.

Engaging the tool with the friction surface of the brake rotor may include positioning the plunger substantially perpendicular to the friction surface. Engaging the tool with the friction surface may include positioning the sleeve between a brake carrier and a bottom side of the backplate. The brake carrier may receive the brake pad assembly. Engaging the tool with the friction surface may include placing an end of the tool in contact with the friction surface.

Engaging the probe with the backplate may include moving the probe with respect to the sleeve so that the probe engages a side of the backplate that faces toward the brake rotor.

Measuring the friction material with the plunger indicator region may include visually determining where the plunger indicator region is aligned with the second end of the sleeve.

In at least one embodiment, a method of measuring friction material of a brake pad assembly is provided. The method includes providing a tool that has a sleeve that defines a sleeve hole and that has a sleeve indicator region disposed on an outer side of the sleeve, a plunger that has a plunger body that is received in the sleeve hole, and a ground plate that is moveably disposed on the sleeve. The tool is engaged with a brake carrier that receives the brake pad assembly. The ground plate is engaged with a brake caliper that is slidably mounted to the brake carrier. The friction material is measured with the sleeve indicator region.

Engaging the tool with the brake carrier may include engaging an end of the tool with the brake carrier. Engaging the tool with the brake carrier may include positioning the sleeve substantially parallel to an axis of rotation of the brake rotor.

Engaging the ground plate with the brake caliper may include engaging the ground plate with a cap of the brake caliper that closes a guide pin opening in the brake caliper. The guide pin opening may receive a guide pin assembly. The guide pin assembly may be fixedly mounted to the brake carrier. The brake caliper may be moveably disposed on the guide pin assembly. Engaging the ground plate may include engaging the ground plate with an exterior side of the That faces away from the brake pad assembly. Engaging the ground plate may include positioning the ground plate substantially perpendicular to an axis along which the plunger extends.

Measuring the friction material may include visually determining where the ground plate is aligned with the sleeve indicator region.

### BRIEF DESCRIPTION OF THE DRAWINGS

FIG. 1 is a perspective view of an example of a brake assembly.

FIG. 2 is a perspective view of an example of a tool for measuring friction material of a brake pad assembly that is provided with the brake assembly.

FIG. 3 is a section view of a portion of the brake assembly along section line 3-3 showing unworn brake pad assemblies and the tool positioned to measure friction material of an inboard brake pad assembly.

FIG. 4 is a magnified view of a portion of FIG. 3.

FIG. 5 is a section view of a portion of the brake assembly showing worn brake pad assemblies and the tool positioned to measure friction material of the inboard brake pad assembly.

FIG. 6 is a side view of the brake assembly with unworn brake pad assemblies and the tool positioned to measure friction material of an outboard brake pad assembly.

FIG. 7 is a side view of the brake assembly with worn brake pad assemblies and the tool positioned to measure friction material of the outboard brake pad assembly.

FIG. 8 is a section view along section line 8-8 with brake pad assemblies and the brake rotor omitted showing an example of a guide pin assembly that is mounted to a brake carrier and that facilitates movement of a brake caliper of the brake assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

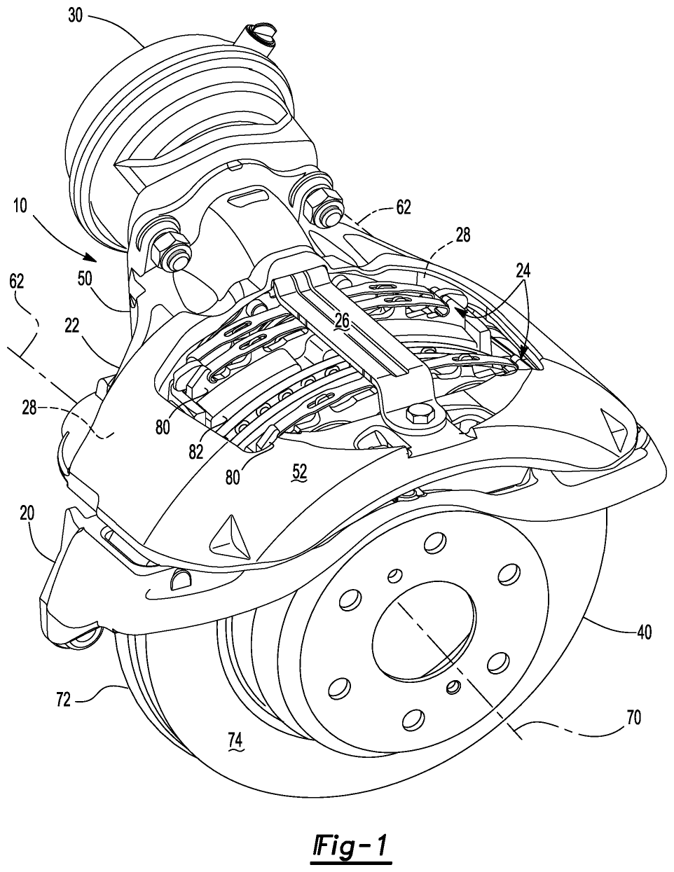

Referring to FIG. 1, an example of a brake assembly 10 is shown. The brake assembly 10 may be provided as part of a vehicle, such as a motor vehicle like a truck, bus, farm equipment, military transport or weaponry vehicle, emergency vehicle, cargo loading equipment for land, air, or marine vessels, or a trailer. The brake assembly 10 may be configured as a disc brake. In at least one configuration, the brake assembly 10 may include a brake carrier 20, a brake caliper 22, a pair of brake pad assemblies 24, and a retainer bracket 26. The brake assembly 10 may also include various components that may facilitate movement of the brake pad assemblies 24, such as one or more guide pin assemblies 28 and a brake actuator 30.

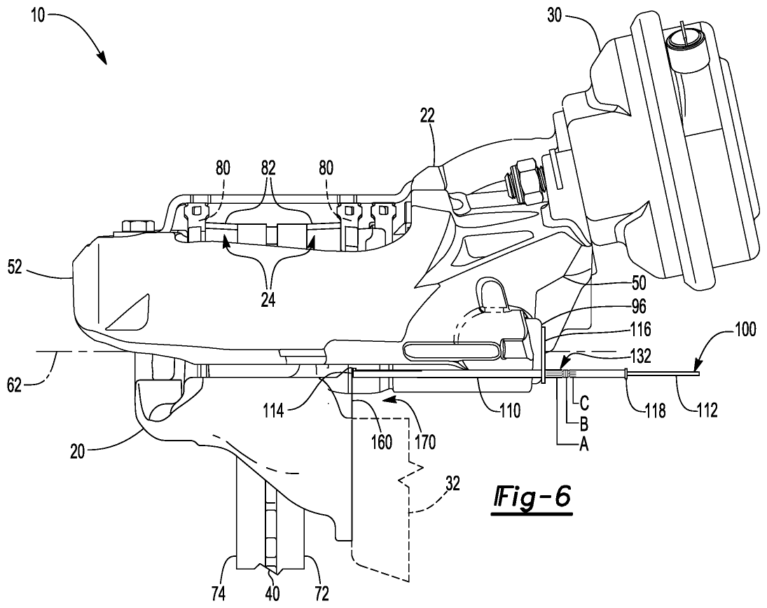

Referring to FIGS. 1 and 6, the brake carrier 20 may be configured to be fixedly mounted to the vehicle. For example, the brake carrier 20 may be directly or indirectly mounted to a structural component 32 (shown in phantom in FIG. 6) like an axle assembly or a steering knuckle. The brake carrier 20 may receive and support the brake pad assemblies 24 in a manner that permits the brake pad assemblies 24 to move along an axis toward and away from a brake rotor 40 that is rotatable with a wheel hub or vehicle wheel while inhibiting rotation of the brake pad assemblies 24 about the axis. For instance, the brake carrier 20 may engage multiple sides of a brake pad assembly 24, such as left, right, and bottom sides. The brake carrier 20 may include a rotor opening that may receive the brake rotor 40. As such, the brake carrier 20 may straddle the brake rotor 40 and help position the brake pad assemblies 24 on opposite sides of the brake rotor 40.

Referring to FIG. 1, the brake caliper 22 may receive various components of the brake assembly 10. In addition, the brake caliper 22 may facilitate positioning of the brake pad assemblies 24 with respect to the brake rotor 40 to facilitate braking of the vehicle. In at least one configuration, the brake caliper 22 may be mounted to the brake carrier 20 and may include a caliper housing 50 and a caliper bridge 52.

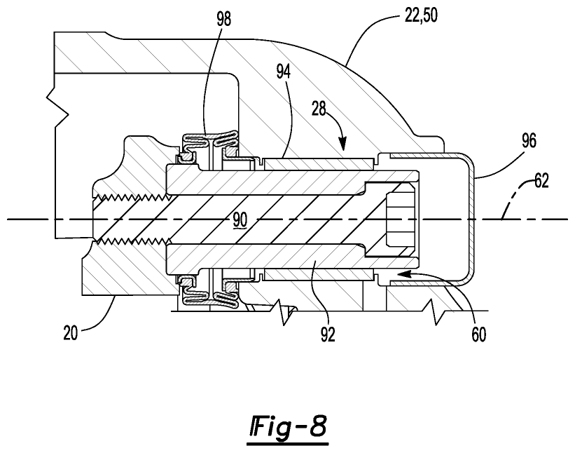

The caliper housing 50, which may also be referred to as a brake caliper housing, may be moveably disposed on the brake carrier 20. For example, the caliper housing 50 may be slidably disposed on a pair of guide pin assemblies 28 that may be fixedly coupled to the brake carrier 20. An example of a guide pin assembly 28 is shown in more detail in FIG. 8. The caliper housing 50 may facilitate mounting of the brake actuator 30. The caliper housing 50 may have a body that may define an internal cavity that may receive or partially receive various components that facilitate movement of the brake pad assemblies 24, such as an operating shaft, yoke, tappet, piston, a wear adjuster mechanism, or combinations thereof. The body may also define an opening through which a shaft of the brake actuator 30 may extend and one or more guide pin openings 60, an example of which is best shown in FIG. 8.

A guide pin opening 60 may be defined by the body of the caliper housing 50. A pair of guide pin openings 60 may be provided that are spaced apart from each other and positioned on opposite lateral sides of the brake pad assemblies 24. A guide pin opening 60 may receive a corresponding guide pin assembly 28 that facilitates sliding movement of the caliper housing 50 with respect to the brake carrier 20 as will be discussed in more detail below. Each guide pin opening 60 may be configured as a through hole that may extend along a guide pin axis 62. The guide pin axes 62 may be disposed substantially parallel to each other. The term “substantially parallel” as used herein means the same as or very close to parallel and includes features or axes that are within ±3° of being parallel each other.

Referring to FIG. 1, the caliper bridge 52 may be integrally formed with the caliper housing 50 or may be a separate part that is fixedly disposed on the caliper housing 50. For example, the caliper bridge 52 may be coupled to the caliper housing 50 with one or more fasteners, such as bolts. In at least one configuration, the caliper bridge 52 may cooperate with the caliper housing 50 to at least partially define an opening that may facilitate insertion and removal of the brake pad assemblies 24.

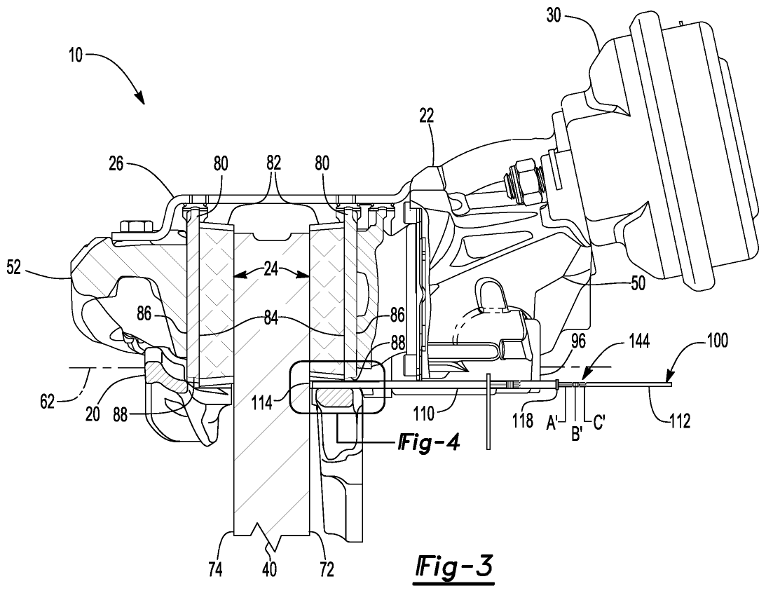

Referring to FIGS. 1 and 3, a pair of brake pad assemblies 24 may be received in and may be supported by the brake carrier 20. The brake pad assemblies 24 may be disposed on opposite sides of the brake rotor 40 and may be engageable with the brake rotor 40 to slow rotation of the brake rotor 40 and an associated wheel hub about a brake rotor axis of rotation 70, which may also be referred to as the axis of rotation of the brake rotor 40. One brake pad assembly 24 may be positioned between the caliper housing 50 and the brake rotor 40 and may be referred to as an inboard brake pad assembly 24 (located to the right of the brake rotor 40 from the perspective shown in FIG. 3). The inboard brake pad assembly 24 may be engageable with a first friction surface 72 or inboard-facing friction surface of the brake rotor 40. The brake pad assembly 24 located on the opposite side of the brake rotor 40 may be positioned between the caliper bridge 52 and the brake rotor 40 and may be referred to as an outboard brake pad assembly 24 (located to the left of the brake rotor 40 from the perspective shown in FIG. 3). The outboard brake pad assembly 24 may be engageable with a second friction surface 74 or outboard-facing friction surface of the brake rotor 40 that may be disposed opposite the first friction surface 72. The first friction surface 72 and the second friction surface 74 may be disposed substantially perpendicular to the brake rotor axis of rotation 70. The brake pad assemblies 24 may include a backplate 80 and friction material 82. The term “substantially perpendicular” is used herein to designate features or axes that are the same as or very close to perpendicular and includes features that are within ±3° of being perpendicular each other.

The backplate 80 may be a structural member of a brake pad assembly 24. The backplate 80 may be configured as a generally flat plate and may be made of any suitable material, such as metal or a metal alloy. As is best shown in FIG. 3, a front side 84 of the backplate 80 may face toward the brake rotor 40. A back side 86 of the backplate 80 may be disposed opposite the front side 84. The back side 86 of the inboard brake pad assembly 24 may engage or contact a moveable component, such as a tappet that be actuated by the brake actuator 30 and moveable toward and away from the brake rotor 40. The back side 86 of the outboard brake pad assembly 24 may engage or contact the caliper bridge 52. A bottom side 88 of the backplate 80 may face away from the retainer bracket 26 and may face toward and may engage a portion of the brake carrier 20.

The friction material 82 may be disposed on the front side 84 of the backplate 80. The friction material 82 may contact the brake rotor 40 during vehicle braking. The friction material 82 may have a thickness that may extend from a side of the friction material 82 that faces toward the brake rotor 40 to an opposite side that faces toward and may engage the front side 84 of the backplate 80. As such, the thickness of the friction material 82 may extend substantially perpendicular to the direction of travel of the brake pad assembly 24. The thickness of the friction material 82 may decrease due to wear that occurs during braking and contact with a corresponding friction surface of the brake rotor 40.

Referring to FIGS. 1 and 3, the retainer bracket 26, if provided, may be removably mounted to the brake caliper 22. For example, the retainer bracket 26 may extend across the brake pad assemblies 24 and the opening in the brake caliper 22 to help retain the brake pad assemblies 24 in the brake carrier 20 when the retainer bracket 26 is secured to the brake caliper 22. Conversely, the retainer bracket 26 may be detached from or removed from the brake caliper 22 to permit removal of the brake pad assemblies 24 or installation of the brake pad assemblies 24 via the opening.

Referring to FIG. 8, one or more guide pin assemblies 28 may slidably couple the caliper housing 50 to the brake carrier 20 such that the caliper housing 50 may slide along the guide pin axis 62 with respect to at least a portion of the guide pin assembly 28. A guide pin assembly 28 may extend from the brake carrier 20 into a corresponding guide pin opening 60. A guide pin assembly 28 may have any suitable configuration. For instance, a guide pin assembly 28 may include a fastener 90, a sleeve 92, and at least one bushing 94.

The fastener 90 may fixedly couple the sleeve 92 to the brake carrier 20. The fastener 90 may have any suitable configuration. For instance, the fastener 90 may be configured as a bolt, such as a carriage bolt, that may be received in a fastener hole of the brake carrier 20.

The sleeve 92 may receive the fastener 90. For instance, the sleeve 92 may be configured as a hollow tube that may receive the fastener 90 and that may be at least partially received in the guide pin opening 60 of the caliper housing 50. The sleeve 92 may be fixedly positioned or stationary with respect to the brake carrier 20.

One or more bushings 94 may be received or partially received in the guide pin opening 60. A bushing 94 may encircle the sleeve 92 and may extend from the sleeve 92 to the caliper housing 50. A bushing 94 may facilitate sliding of the caliper housing 50 along the guide pin axis 62 and with respect to the brake carrier 20.

One or more sealing components may be provided with or associated with a guide pin assembly 28 to help isolate a guide pin opening 60 and components that may be received in the guide pin opening 60 from the surrounding environment. For instance, a sealing component may inhibit contaminants such as particulates and moisture or water, from entering the guide pin opening 60, thereby helping maintain smooth sliding movement of the caliper housing 50 and inhibiting corrosion of internal components. A sealing component may be completely received inside the guide pin opening 60, partially received inside the guide pin opening 60, or may be located outside the guide pin opening 60. A sealing component may have any suitable configuration. For instance, a sealing component may be configured as a seal, such as an O-ring, that may encircle the sleeve 92 and may extend from the sleeve to the caliper housing 50 or and intervening component. Alternatively or in addition, a sealing component may be configured as a cover, cap, boot, or the like. In the configuration shown in FIG. 8, one sealing component is configured as a cap 96 while the other sealing component is configured as a flexible boot 98.

The cap 96 may be provided to cover the end of the guide pin opening 60 that faces away from the brake carrier 20. In at least one configuration, the cap 96 may be received in the guide pin opening 60. The cap 96 may partially receive the guide pin assembly 28.

The flexible boot 98 may extend between the brake carrier 20 and the brake caliper 22 or between the guide pin assembly 28 and the caliper housing 50. The flexible boot 98 may flex or change in length in response to movement of the brake caliper 22. For instance, the flexible boot 98 may expand or unfold when the brake caliper 22 moves in a first direction with respect to the brake carrier 20 and may contract or fold when the brake caliper 22 moves in a second direction with respect to the brake carrier 20.

Referring to FIG. 1, the brake actuator 30 may be mounted to the brake caliper 22. In at least one configuration, the brake actuator 30 may be mounted to the back wall of the caliper housing 50. Force exerted by the brake actuator 30 may actuate the brake pad assemblies 24.

The brake actuator 30 may be operatively connected to a wear adjuster mechanism that may be received in the internal cavity of the caliper housing 50. The wear adjuster mechanism may be configured to maintain a desired running clearance between the brake pad assemblies 24 and the brake rotor 40 when the brake pad assemblies 24 are retracted or in a retracted position. As an overview, the wear adjuster mechanism may permit the axial position of a brake pad assembly to be adjusted or move closer to the brake rotor 40 in response to wear of the friction material 82. The wear adjuster mechanism may be provided in various configurations, some examples of which are disclosed in United States Patent Publication No. 2019/0024740, which is hereby incorporated by reference in its entirety.

Operation of the brake assembly 10 will now be described in more detail. As an overview, the brake assembly 10 may start in a retracted position or retracted state in which braking of the vehicle is not requested. As such, the brake pad assemblies 24 may be retracted away from the brake rotor 40 and spaced apart from the brake rotor 40. In response to a vehicle braking command, the brake actuator 30 may be operated to exert force that may move the inboard brake pad assembly 24 into contact with the inboard-facing first friction surface 72 of the brake rotor 40. A reaction force may then move the brake caliper 22 along the guide pin axes 62 with respect to the brake carrier 20 to actuate the outboard brake pad assembly 24 that is disposed between the brake rotor 40 and the caliper bridge 52 into engagement with the outboard-facing second friction surface 74 of the brake rotor 40 to help slow rotation of the brake rotor 40 and an associated vehicle wheel. Retracting or releasing the brake actuator 30 may allow the actuation sequence to proceed in reverse.

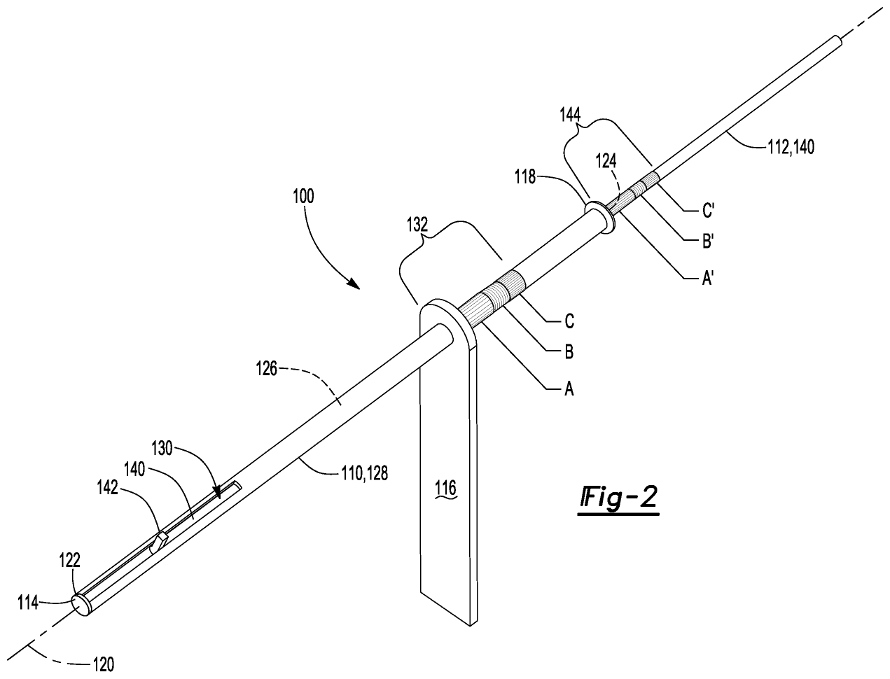

Referring to FIG. 2, an example of a tool 100 for measuring friction material 82 of at least one brake pad assembly 24 is shown. In at least one configuration, the tool 100 may include a sleeve 110, a plunger 112, an end cap 114, a ground plate 116, a protrusion 118, or combinations thereof.

The sleeve 110 may extend along or extend around an axis 120. In at least one configuration, the sleeve 110 may include a first end 122, a second end 124, a sleeve hole 126, an outer side 128, a sleeve slot 130, a sleeve indicator region 132, or combinations thereof.

The first end 122 may be disposed at an end of the sleeve 110. In at least one configuration, the first end 122 may be disposed substantially perpendicular to the axis 120.

The second end 124 may be disposed opposite the first end 122. In at least one configuration, a second end 124 may be disposed substantially perpendicular to the axis 120.

The sleeve hole 126 may extend between the first end 122 and the second end 124. For instance, the sleeve hole 126 may extend from the first end 122 to the second end 124. The sleeve hole 126 may extend along the axis 120 and may receive the plunger 112.

The outer side 128 may be disposed opposite the sleeve hole 126. As such, the outer side 128 may face away from the axis 120. In at least one configuration, the outer side 128 or a portion thereof may encircle the axis 120.

The sleeve slot 130 may extend through the sleeve 110. For instance, the sleeve slot 130 may extend from the sleeve hole 126 to the outer side 128. The sleeve slot 130 may extend between the first end 122 and the second end 124 of the sleeve 110. For example, the sleeve slot 130 may extend from an end of the sleeve 110 or may be spaced apart from the ends of the sleeve 110. In the configuration shown, the sleeve slot 130 extends from the first end 122 toward the second end 124.

The sleeve indicator region 132 may provide visual information indicative of the state of wear of the friction material of a brake pad assembly 24, such as the outboard brake pad assembly. The sleeve indicator region 132 may be provided on a visible exterior surface of the tool 100, such as the outer side 128 of the sleeve 110. The sleeve indicator region 132 may include one or more markings that may indicate the state of wear. The markings may be of any suitable type. For instance, a single marking may be provided that may designate or separate states of wear between a “do not replace” indication and a “replace” indication. As other examples, one or more bands or color-coded regions may be provided that indicate different levels of wear. For instance, a first band A (e.g., green band) may indicate that a brake pad assembly 24 has ample friction material 82, a second band B (e.g., yellow band) may indicate that the brake pad assembly 24 has sufficient friction material 82 for use but has worn to the point that replacement may be needed soon, and a third band C (e.g., red band) that may indicate that friction material 82 of the brake pad assembly 24 is at or near the end of its useful life and should be replaced. As such, the first, second, and third bands A, B, C may represent increasing levels of wear of the friction material 82. As another example, markings may be configured as a scale or ruler that may include delineations and numbers or characters that display or represent the thickness of the friction material. It is contemplated that the markings may be raised, recessed, aligned with the outer side 128, or combinations thereof. In addition, it is also contemplated that multiple marking sections or sets of markings may be provided to facilitate wear assessments or wear measurements for different brake assembly configurations.

The plunger 112 may be received in the sleeve hole 126. In addition, the plunger 112 may be moveable along the axis 120 with respect to the sleeve 110. In at least one configuration, the plunger 112 may include a plunger body 140, a probe 142, or combinations thereof.

The plunger body 140 may be received in the sleeve hole 126 and may be moveable with respect to the sleeve 110. The plunger body 140 may have any suitable configuration that is compatible with the sleeve hole 126. For instance, the plunger body 140 may have the same cross-sectional shape or a similar cross-sectional shape as the sleeve hole 126, such as a circular cross section. In addition, the plunger body 140 may have a slightly smaller cross section (e.g., outside diameter) than the sleeve hole 126 to facilitate movement of the plunger body 140 with respect to the sleeve 110. The plunger body 140 may extend along the axis 120 and may have a greater axial length than the sleeve 110. In at least one configuration, the plunger body 140 may have a plunger indicator region 144.

The plunger indicator region 144 may provide visual information indicative of a state of wear of the friction material 82 of a brake pad assembly 24, such as the inboard brake pad assembly 24 as will be discussed in more detail below. The plunger indicator region 144 may be provided on a visible exterior surface of the tool 100, such as an exterior side of the plunger 112 that may face away from the axis 120. The plunger indicator region 144 may include one or more markings that may indicate the state of wear of the friction material 82. The markings may be of any suitable type and quantity as previously discussed with respect to the sleeve indicator region 132. For instance, the first, second, and third bands A′, B′, C′ may be provided and may represent increasing levels of wear of the friction material 82. As previously discussed, it is contemplated that multiple marking sections or sets of markings may be provided to facilitate wear assessments or wear measurements for different brake assembly configurations.

The probe 142 may extend from the plunger body 140 in a direction that extends away from the axis 120. For instance, the probe 142 or a portion thereof may be disposed substantially perpendicular to the axis 120. The probe 142 may extend through the sleeve slot 130. In addition, the probe 142 may extend past the outer side 128 of the sleeve 110. In such a configuration, the probe 142 may inhibit the ground plate 116 from sliding past the probe 142 and off the sleeve 110 (e.g., past the first end 122 of the sleeve 110).

The end cap 114 may be disposed at an end of the sleeve 110, such as the first end 122. The end cap 114 may act as a stop that may inhibit removal of the plunger 112 from the sleeve hole 126. A side of the end cap 114 that faces away from the sleeve hole 126 may be disposed substantially perpendicular to the axis 120 and may be configured to engage either the brake carrier 20 or the brake rotor 40 as will be discussed in more detail below. It is also contemplated that the end cap 114 may be omitted, that the first end 122 of the sleeve 110 may be configured to engage the brake carrier 20 or the brake rotor 40, and that a component may be inserted into the sleeve hole 126 or that the first end 122 of the sleeve 110 or a portion of the sleeve 110 may extend toward the axis 120 further than the inner surface of the sleeve 110 that defines the sleeve hole 126 to act as a stop. If provided, the end cap 114 may define an end of the tool 100 that may be engaged with the brake carrier 20 or the first friction surface 72 of the brake rotor 40 as will be discussed in more detail below.

The ground plate 116 may be moveably disposed on the sleeve 110. For instance, the ground plate 116 may have a ground plate hole through which the sleeve 110 may extend. The ground plate 116 may be axially positioned or positioned along the axis 120 between the probe 142 and the second end 124 of the sleeve 110. The ground plate 116 or a portion thereof may extend substantially perpendicular to the axis 120 when used to measure the friction material 82.

The protrusion 118 may be disposed proximate the second end 124 of the sleeve 110. In the configuration shown, a side of the protrusion 118 that faces away from the end cap 114 and first end 122 is aligned with the second end 124 of the sleeve 110; however, it is contemplated the protrusion 118 may be offset from the second end 124 and positioned closer to the first end 122 than shown. The protrusion 118 may prevent the ground plate 116 from sliding off the second end 124 of the sleeve 110. As such, the protrusion 118 and the probe 142 may cooperate to inhibit or prevent removal of the ground plate 116 from the sleeve 110. The protrusion 118 may have any suitable configuration. For instance, the protrusion 118 may be integrally formed with the sleeve 110 and may be a flared or enlarged portion of the sleeve 110 that may extend away from the axis 120. Alternatively, the protrusion 118 may be a separate component from the sleeve 110 that may extend away from the outer side 128, such as a collar, ring, clamp, or the like. A protrusion 118 that is a separate component may be secured to the sleeve 110 in any suitable manner, such as with a fastener, interference fit, adhesive, etc.

Referring to FIGS. 3-7, method steps associated with measuring friction material of a brake assembly will now be described. More specifically, friction material 82 of a brake pad assembly 24 may be measured with the tool 100 when the brake pad assembly 24 is installed on the brake assembly 10 (i.e., received in the brake carrier 20 of the brake assembly 10) and when the brake rotor 40 is received by the brake assembly 10. As such, friction material 82 may be measured when the brake assembly 10 is installed on a vehicle and without removing the brake pad assembly 24 from the brake assembly 10. Friction material 82 may be measured when the brake pad assembly 24 is retracted i.e., when the friction material 82 is spaced apart from the brake rotor 40) or extended (i.e., when the friction material 82 is in contact with a friction surface of the brake rotor 40), noting that the sleeve indicator region 132 and the plunger indicator region 144 of the tool 100 may be positioned slightly differently when calibrated for measuring a retracted brake pad assembly as compared to an extended brake pad assembly to account for the presence or absence of the running clearance. Friction material 82 may be measured when the brake rotor 40 is not rotating to prevent wear or potential damage to the tool 100.

The tool 100 may allow the friction material 82 of the inboard brake pad assembly 24 and the friction material 82 of the outboard brake pad assembly 24 to be measured independently. This may allow more precise measurement of the friction material 82 that is present on a specific brake pad assembly 24 since the friction material 82 may not wear evenly on the inboard brake pad assembly 24 and the outboard brake pad assembly 24.

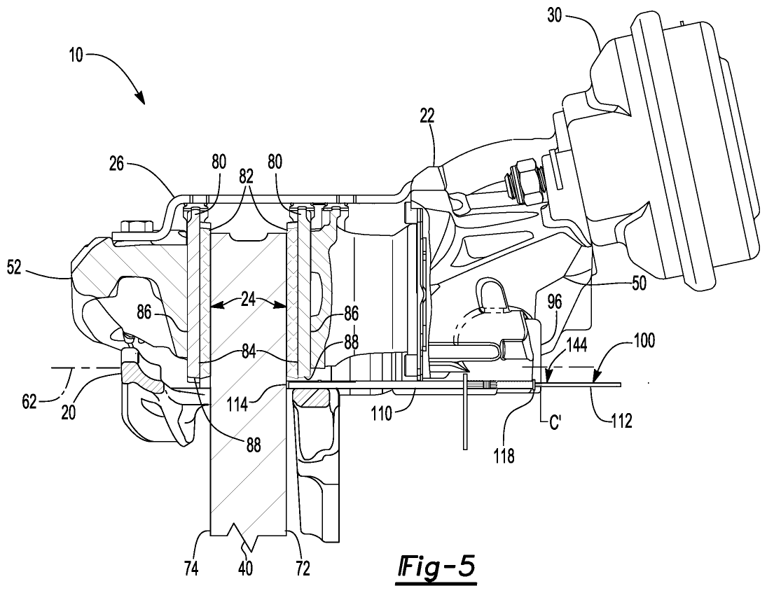

Referring to FIGS. 3-5, a method of measuring friction material 82 of a brake pad assembly 24, such as the inboard brake pad assembly 24, will now be described. FIG. 3 illustrates an example of measuring the thickness of friction material 82 that is not worn. FIG. 5 illustrates an example of measuring the thickness of friction material 82 that is fully worn or nearly fully worn.

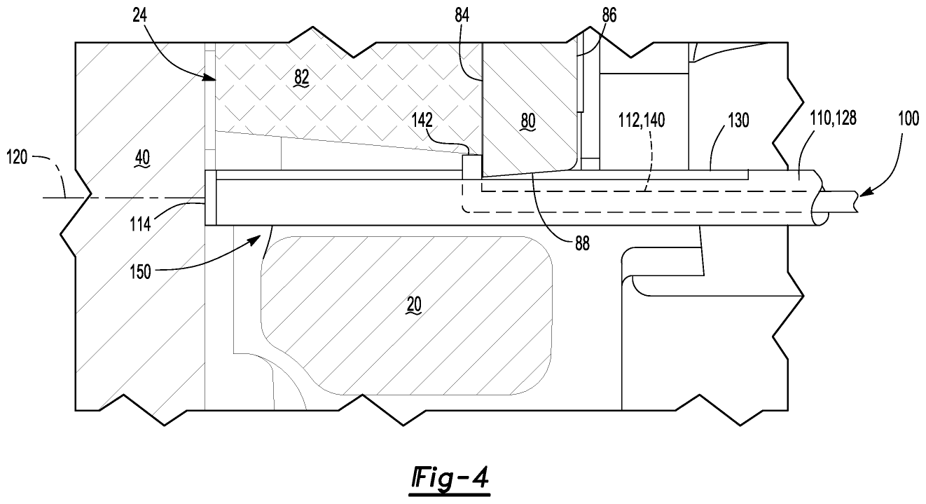

Referring to FIG. 3, the tool 100 may be oriented such that the end cap 114 or the first end 122 of the sleeve 110 may face toward the first friction surface 72 or inboard-facing friction surface of the brake rotor 40, which faces to the right from the perspective shown. As such, the axis 120 of the tool 100 and thus the sleeve 110 and plunger 112 may be disposed generally parallel to the brake rotor axis of rotation 70 and generally perpendicular to the first friction surface 72. As is best shown in FIG. 4, the first end 122 may be inserted into a gap 150 that is located between the brake carrier 20 and the backplate 80 of the inboard brake pad assembly 24. As such, the sleeve 110 may be positioned between the brake carrier 20 and the bottom side 88 of the backplate 80.

Next, the tool 100 may be engaged with the first friction surface 72 of the brake rotor 40. Engaging the tool 100 with the first friction surface 72 may include placing an end of the tool 100, such as the end cap 114, into contact with the first friction surface 72. The plunger 112 and the axis 120 may be positioned substantially perpendicular to the first friction surface 72. The tool 100 may be oriented so that the probe 142 may extend toward the friction material 82 or upward from the perspective shown in FIGS. 3 and 4. The probe 142 may be spaced apart from the friction material 82 when properly positioned. It is also contemplated that the friction material 82 may be contoured or provided with a profile that provides clearance to the probe 142.

Next, the probe 142 may be engaged with the backplate 80 of the brake pad assembly 24 upon which the friction material 82 is disposed (e.g., the backplate 80 of the inboard brake pad assembly 24). This is best illustrated with reference to FIG. 4. Engaging the probe 142 with the backplate 80 may include moving the plunger 112 along the axis 120. For instance, when the probe 142 is located between or is axially positioned the backplate 80 and the brake rotor 40, the sleeve 110 may be held in a stationary position so that the sleeve 110 or end cap 114 engages the brake rotor 40 and the plunger 112 may be pulled through the sleeve 110 and away from the brake rotor 40 until the probe 142 contacts the front side 84 of the backplate 80 that faces toward the brake rotor 40.

Next, the friction material 82 may be measured with the plunger indicator region 144. The friction material 82 may be measured by determining where the second end 124 of the sleeve 110 and/or the protrusion 118 are aligned with the plunger indicator region 144. Such a determination may be made visually. The marking or markings at that point may be indicative of the thickness of the friction material 82. In FIG. 3, the second end 124 and protrusion 118 are aligned with the first band A′ of the plunger indicator region 144, thereby indicating that the brake pad assembly 24 has ample friction material 82.

As the thickness of the friction material 82 of the inboard brake pad assembly 24 decreases, the backplate 80 of the inboard brake pad assembly 24 will move closer to the brake rotor 40. As a result, the probe 142 will also move closer to the brake rotor 40 and the plunger 112 will extend further into the sleeve hole 126. An example of this is shown in FIG. 5.

Referring to FIG. 5, an example of an inboard brake pad assembly 24 with worn friction material 82 is shown. The tool 100 is positioned as previously described. The plunger 112 extends further into the sleeve hole 126 such that the second end 124 of the sleeve 110 or protrusion 118 is aligned with the third band C′ of the plunger indicator region 144, thereby indicating that the inboard brake pad assembly 24 should be replaced.

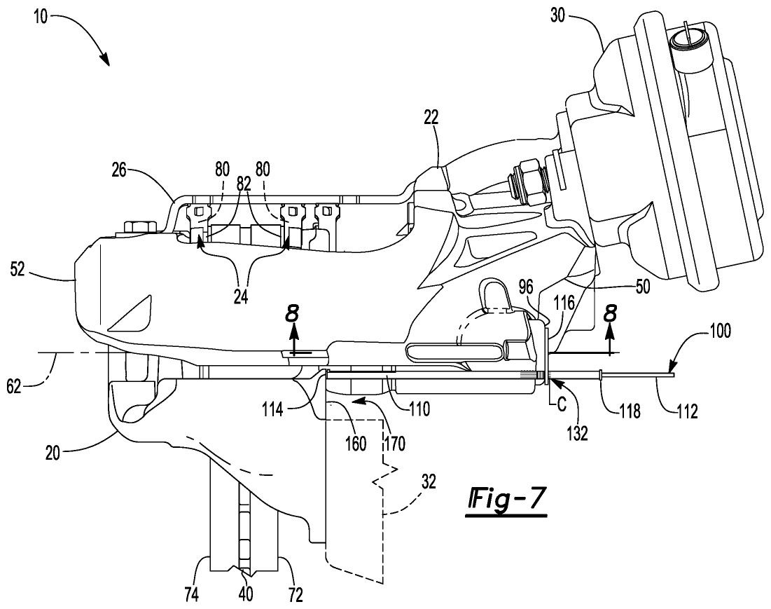

Referring to FIGS. 6 and 7, a method of measuring friction material 82 of a brake pad assembly 24, such as the outboard brake pad assembly 24, will now be described.

Referring to FIG. 6, the tool 100 may be oriented such that the first end 122 of the sleeve 110 or the end cap 114 faces toward an inboard facing surface 160 of the brake carrier 20, which faces to the right from the perspective shown. As such, the axis 120 of the tool 100 and thus the sleeve 110 and plunger 112 may be disposed generally parallel to the brake rotor axis of rotation 70 or generally perpendicular to the inboard facing surface 160. The first end 122 may be inserted into a gap 170 that is located between the brake caliper 22 and the structural component 32 upon which the brake assembly 10 is mounted. As such, the sleeve 110 may not be positioned in the gap 150 between the brake carrier 20 and a bottom side 88 of the backplate 80 as depicted in FIGS. 3 and 5.

Next, the tool 100 may be engaged with the brake carrier 20. Engaging the tool 100 with the brake carrier 20 may include placing an end of the tool 100, such as the end cap 114 into contact with the inboard facing surface 160 of the brake carrier 20. The plunger 112 and the axis 120 may be positioned substantially perpendicular to the inboard facing surface 160.

Next, the ground plate 116 may be engaged with the brake caliper 22. Engaging the ground plate 116 with the brake caliper 22 may include sliding the ground plate 116 along the sleeve 110 and along the axis 120, rotating the ground plate 116 about the sleeve 110 so that the ground plate 116 extends toward the caliper housing 50 of the brake caliper 22, or both. In the configuration shown, the ground plate 116 or a portion thereof is positioned substantially perpendicular to the axis 120. In at least one configuration, the ground plate 116 may engage or contact the cap 96 of the brake caliper 22; however, it is contemplated that the ground plate 116 may contact a different surface of the brake caliper 22, such as a surface that is adjacent to the cap 96 or a surface that is oriented in a compatible manner with the ground plate 116 for measurement purposes. In FIG. 6, a side of the ground plate 116 that faces toward the brake rotor 40 may be placed into engagement or contact with an exterior side of the cap 96 that faces away and the brake pad assembly 24 and the brake rotor 40. The exterior side of the cap 96 may be disposed substantially perpendicular to the axis 120 and the guide pin axis 62.

Next, the friction material 82 may be measured with the sleeve indicator region 132. The friction material 82 may be measured by determining where the ground plate 116 is aligned with the sleeve indicator region 132. Such a determination may be made visually. The marking or markings at that point may be indicative of the thickness of the friction material 82. In FIG. 6, the ground plate 116 is aligned with a first band A of the sleeve indicator region 132, thereby indicating that the brake pad assembly 24 has ample friction material 82.

As the thickness of the friction material 82 of the outboard brake pad assembly 24 decreases, the backplate 80 of the outboard brake pad assembly 24 will move closer to the brake rotor 40. As a result, the brake caliper 22 and its cap 96 will slide to the right from the perspective in position shown in FIG. 6 and the ground plate 116 will move toward the second end 124 of the tool 100. An example of this is shown in FIG. 7.

Referring to FIG. 7, an example of and outboard brake pad assembly 24 with fully worn or nearly fully worn friction material 82 is shown. The tool 100 is positioned as previously described. The ground plate 116 is moved along the sleeve 110 and the axis 120 further toward the second end 124 of the sleeve 110 such that the ground plate 116 is aligned with the third band C of the sleeve indicator region 132, thereby indicating that the outboard brake pad assembly 24 should be replaced.

A tool as described above may allow brake pad assemblies to be independently measured without removing the brake pad assemblies from the brake assembly and while the brake assembly is installed on a vehicle, which may reduce inspection time and associated costs. The thickness of the friction material may be accurately assessed quickly to determine whether replacement of a brake pad assembly is warranted. Thickness of the friction material may be measured indirectly and without contacting the friction material, which may make it easier to obtain measurements when the brake assembly and brake pads are installed and the brake rotor is present. In addition, indirect measurements of the friction material thickness may remove or reduce the likelihood of measurement error that may occur if the friction material is pitted or wear of the friction material is not substantially perpendicular to the direction of travel of the brake pad assembly. The tool may be compact, easy-to-use, inexpensive to manufacture, and may have few moving parts. In addition, the tool may allow friction material of inboard and outboard brake pad assemblies to be measured or assessed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tool for measuring friction material of at least one brake pad assembly, the tool comprising:
a sleeve that includes:
a sleeve hole that extends along an axis; and
a sleeve slot that extends through the sleeve from the sleeve hole to an outer side of the sleeve that faces away from the axis;
a plunger that is received in the sleeve hole and moveable along the axis with respect to the sleeve, the plunger including:
a plunger body that is received in the sleeve hole and that has a plunger indicator region that provides visual information indicative of a state of wear of friction material of an inboard brake pad assembly; and
a probe that extends from the plunger body through the sleeve slot and past the outer side of the sleeve.

2. The tool of claim 1 wherein the sleeve has a first end and a second end disposed opposite the first end, wherein the sleeve hole extends from the first end to the second end and the sleeve slot extends from the first end toward the second end.

3. The tool of claim 2 further comprising an end cap that is disposed at the first end of the sleeve, wherein the end cap inhibits removal of the plunger from the sleeve hole.

4. The tool of claim 1 further comprising a ground plate that is moveably disposed on the sleeve and that has a ground plate hole through which the sleeve extends.

5. The tool of claim 4 wherein the sleeve hole extends between a first end and a second end of the sleeve and wherein the ground plate is positioned along the axis between the probe and the second end of the sleeve.

6. The tool of claim 5 wherein the sleeve has a protrusion that is disposed proximate the second end of the sleeve, wherein the protrusion and the probe inhibit removal of the ground plate from the sleeve.

7. The tool of claim 1 wherein a sleeve indicator region that provides visual information indicative of the state of wear of friction material of an outboard brake pad assembly is provided on the outer side of the sleeve.

8. A method of measuring friction material of a brake pad assembly, the method comprising:
providing a tool that has a sleeve that defines a sleeve hole and a sleeve slot that extends through the sleeve from the sleeve hole, a plunger that has a plunger body that is received in the sleeve hole, the plunger body having a plunger indicator region, and a probe that extends from the plunger body through the sleeve slot;
engaging the tool with a friction surface of a brake rotor that is configured to be engaged by the friction material;
engaging the probe with a backplate of the brake pad assembly upon which the friction material is disposed; and
measuring the friction material with the plunger indicator region.

9. The method of claim 8 wherein engaging the tool with the friction surface of the brake rotor includes positioning the plunger substantially perpendicular to the friction surface.

10. The method of claim 8 wherein engaging the tool with the friction surface of the brake rotor includes positioning the sleeve between a brake carrier that receives the brake pad assembly and a bottom side of the backplate.

11. The method of claim 8 wherein engaging the tool with the friction surface includes placing an end of the tool in contact with the friction surface.

12. The method of claim 11 wherein the end of the tool is defined by an end cap that is disposed at a first end of the sleeve, wherein the end cap inhibits removal of the plunger from the sleeve hole.

13. The method of claim 8 engaging the probe with the backplate includes moving the probe with respect to the sleeve so that the probe engages a side of the backplate that faces toward the brake rotor.

14. The method of claim 8 wherein the sleeve has a first end that faces toward the brake rotor and a second end disposed opposite the first end, wherein measuring the friction material with the plunger indicator region includes visually determining where the plunger indicator region is aligned with the second end.

15. A method of measuring friction material of a brake pad assembly, the method comprising:
providing a tool that has a sleeve that defines a sleeve hole, a sleeve indicator region disposed on an outer side of the sleeve, a plunger that has a plunger body that is received in the sleeve hole, and a ground plate that is moveably disposed on the sleeve and has a ground plate hole through which the sleeve extends;
engaging the tool with a brake carrier that receives the brake pad assembly;
engaging the ground plate with a brake caliper that is slidably mounted to the brake carrier; and
measuring the friction material with the sleeve indicator region.

16. The method of claim 15 wherein engaging the tool with the brake carrier includes engaging an end of the tool with the brake carrier and positioning the sleeve substantially parallel to an axis of rotation of a brake rotor.

17. The method of claim 15 engaging the ground plate with the brake caliper includes engaging the ground plate with a cap of the brake caliper and that closes a guide pin opening in the brake caliper that receives a guide pin assembly that is fixedly mounted to the brake carrier and upon which the brake caliper is moveably disposed.

18. The method of claim 17 wherein engaging the ground plate includes engaging the ground plate with an exterior side of the cap that faces away from the brake pad assembly.

19. The method of claim 15 wherein engaging the ground plate includes positioning the ground plate substantially perpendicular to an axis along which the plunger extends.

20. The method of claim 15 wherein measuring the friction material includes visually determining where the ground plate is aligned with the sleeve indicator region.
